(19) United States
(12) Patent Application Publication
(10) Pub. No.: US 2011/0237184 A1
(43) Pub. Date: Sep. 29, 2011

(54) ON-BOARD DEVICE, INFORMATION COMMUNICATION SYSTEM, METHOD FOR CONTROLLING COMMUNICATION OF ON-BOARD DEVICE, AND COMPUTER PROGRAM THEREFOR

(75) Inventors: Kunihiro Minoshima, Kanagawa (JP); Takehiko Shioda, Kawasaki (JP); Akihiro Tozaki, Kawasaki (JP); Kazunori Hashimoto, Tokyo (JP); Nobuhiro Ishizuka, Kawasaki (JP); Ken Murayama, Kawasaki (JP); Junichi Shirakawa, Nara (JP); Shuji Daioku, Osaka (JP); Nobuo Kusumoto, Osaka (JP); Akira Tojima, Nara (JP)

(73) Assignees: PIONEER CORPORATION, KANAGAWA (JP); SHARP KABUSHIKI KAISHA, OSAKA (JP)

(21) Appl. No.: 13/061,241

(22) PCT Filed: Jul. 30, 2009
(86) PCT No.: PCT/JP2009/003622

§ 371 Date: May 13, 2011

(30) Foreign Application Priority Data
Aug. 28, 2008 (JP) 2008-219500

(51) Int. Cl. H04B 7/24

(52) U.S. Cl. 455/39

(57) ABSTRACT

An on-board device 10 has: a communication unit 110 that carries out communication with a portable device 30 that has a transfer reservation function of place information indicating an arbitrary place; a place information acquisition unit 130 that acquires the place information from the portable device 30 after the communication is established; a place information determination unit 140 that determines a category of processing relating to the place information acquired by the place information acquisition unit 130; a place information processing unit 200 that at least registers a place or sets a destination using the place information based on the category determined by the place information determination unit 140; and a route guidance unit 180 that guides a route to a destination when the destination has been set.

### TECHNICAL FIELD

The present invention relates to an on-board device communicable with a portable device, an information communication system, a method for controlling communication of an on-board device, and a computer program therefor.

### BACKGROUND ART

Conventionally known on-board devices include a receiver for receiving place information from a portable device, a travel route planner for setting a travel route based on the received place information, and a route guide for giving route guidance based on the planned travel route (see Patent Document 1, for example). Such on-board devices automatically plan for travel route based on the place information registered in the portable device, and the user who has got on the vehicle does not have to set his or her in the on-board device. Some other on-board devices are known to obtain schedule data from a portable device for setting a destination (see Patent Document 2, for example). Such on-board devices automatically set up a destination based on place information included in the schedule data registered in the portable device.
[Patent Document 1] JP-A-2003-177027
[Patent Document 2] JP-A-2000-146617

### SUMMARY OF THE INVENTION

### Problems to be Solved

With the on-board device disclosed in Patent Document 1, all place information registered in the portable device may not necessarily be registered for the purpose of setting destinations. For example, a car navigation device typically has a function for registering places (which allows the user to save the places such as home, workplace or other places the user frequently visits or the places saved in the past), and the function may allow the user to save place information for the purpose of registering the places, so that the place information can be transferred to the on-board device from the portable device. With the on-board device disclosed in Patent Document 2, the schedule data registered in the portable device may not always involve transportation by vehicle (during which the user needs route guidance). For example, the schedule data may be meant for other means of transportation such as train or walk to arrive to the destination. In this sense, the place information registered in a portable device has been used only for setting a destination in related-art on-board devices, and hence the user is not able to register place information for the purpose of simply saving places (registering places) in the portable device.

In view of the above-described problems, an object of the present invention is to provide an on-board device and an information communication system able to perform appropriate processing based on a category of place information obtained from a portable device, a method for controlling communication of an on-board device and a computer program therefor.

### Means to Solve the Problems

An on-board device according to an aspect of the present invention includes a communication unit that carries out communication with a portable device that has a transfer reservation function of place information indicating an arbitrary place, a place information acquisition unit that acquires the place information from the portable device after the communication is established, a place information determination unit that determines a category of processing relating to the place information acquired by the place information acquisition unit, and a place information processing unit that at least registers a place or sets a destination using the place information based on the category determined by the place information determination unit.

A method for controlling communication of an on-board device according to another aspect of the invention is a method for controlling communication of an on-board device communicable with a portable device having a transfer reservation function of place information indicating an arbitrary place. The method includes, performed by the on-board device, acquiring the place information from the portable device after communication is established, determining a category of processing relating to the place information acquired, and at least registering a place or setting a destination using the place information based on the determined category.

With the configurations above, the category of the place information is determined after the place information is acquired and either a destination is set or a place is registered depending on the category determined, and thus appropriate processing is performed depending on the category of the place information. In other words, the place information received from the portable device is determined to be whether for the purpose of registering the place or setting the destination, and hence those two categories of the place information can be distinguishably saved in the portable device. Accordingly, place registration or destination setting can be performed in advance on the portable device, thus saving the effort in doing so on the on-board device after the user gets on the vehicle.

It is noted that “place information” includes information of an arbitrary place itself represented by latitude and longitude, a map code, an address, a telephone number or other information that may indirectly indicate the arbitrary place. When the portable device is a device with an address book such as a portable telephone, address or telephone number information saved in the address book may be acquired as the place information.

The communication with the portable device may be either wired communication or wireless (contactless) communication. It is further noted that “determining a category of processing relating to place information” may be based on presence or absence of additional information about the place information or a type of such additional information, or on the information format (for example, set a destination if in a map code format, and register a place if in an address or telephone number format) of the place information. Furthermore, a category of processing may also be determined based on information separately sent by the portable device soon before or after the place information was sent.

Optionally in the on-board device, the place information is either destination information indicating the destination, or place registration information for registering a place. The place information determination unit determines that the place information acquired by the place information acquisition unit is either the destination information or the place registration information. The place information process unit includes a place registration unit that registers the place based on the place registration information if the place information is determined to be the place registration information, and a destination setting unit that sets the destination based on the destination information if the place information is determined to be the destination information.

Such configuration allows for acquiring two categories of place information, which are the destination information and the place registration information, from the portable device. Accordingly, convenience associated with setting a destination or searching of a destined location on the on-board device improves.

Optionally, the on-board device further includes a transfer reservation check unit that checks with the portable device whether there is any transfer reservation of the place information upon establishment of the communication with the portable device, and the place information acquisition unit acquires the place information from the portable device when the transfer reservation check unit has confirmed that there is a transfer reservation in the portable device.

Such configuration allows for checking whether there is any transfer reservation of place information upon establishment of the communication with the portable device and then acquiring the place information if a transfer reservation is confirmed, and hence does not allow other unintended place information by the user to be acquired. That is because having a transfer reservation of place information supposedly represents that the user wishes to transfer information to the on-board device. Furthermore, a transfer reservation is checked upon establishment of the communication with the portable device, and hence no other special operation is required for the user to acquire place information, and there is no concern associated with missing the information that should have been acquired. In other words, this configuration allows for acquiring the desired place information in a fast and reliable manner.

Optionally, the on-board device further includes a route guidance unit that guides through a route to the destination set by the place information process unit.

Such configuration allows for setting the destination based on the place information acquired from the portable device to guide through a route to the destination. In other words, the invention can be applied to a vehicle guiding apparatus (car navigation apparatus).

Optionally, the on-board device further includes a device-priority setting unit that sets a prioritized device that is one portable device subject to prioritized communication by the communication unit. The place information acquisition unit first attempts to acquire place information from the prioritized device, and when no place information to be transferred is available in the prioritized device and communication with another portable device besides the prioritized device is established by the communication unit, the place information acquisition unit attempts to acquire place information from the another portable device.

Such configuration allows for setting the prioritized device so as to enable an ensured acquisition of the place information that has been transfer-reserved in the prioritized device despite a situation where other wirelessly-communicable portable devices are present inside the vehicle. Furthermore, when no place information to be transferred is confirmed in the prioritized device and communication with another portable device besides the prioritized device is established, the place information acquisition unit attempts to acquire place information from the another device. Hence no change in setting of a prioritized device is required to acquire place information from other portable devices besides the prioritized device.

Optionally, the on-board device further includes a device-priority setting unit that sets a prioritized device that is one portable device subject to prioritized communication by the communication unit. The transfer reservation check unit first checks whether there is any transfer reservation in the prioritized device, and when no transfer reservation is confirmed in the prioritized device and communication with another portable device besides the prioritized device is established by the communication unit, the transfer reservation check unit checks whether there is any transfer reservation in the another device.

Such configuration allows for setting the prioritized device so as to enable an ensured acquisition of the place information that has been transfer-reserved in the prioritized device despite a situation where other wirelessly-communicable portable devices are present inside the vehicle. Furthermore, when no transfer reservation is confirmed in the prioritized device, communication with another portable device besides the prioritized device will be established to check for a transfer reservation therein. Hence, no change in setting of a prioritized device is required to acquire place information from the another portable device besides the prioritized device.

It is preferable, when the communication unit has failed to establish the communication with the prioritized device, to assume that there is no transfer reservation in the prioritized device and to check whether there is a transfer reservation in another portable device.

Optionally, in the on-board device, when the transfer reservation check unit checks whether there is any transfer reservation in another portable device, and the place information process unit has set a destination based on the place information acquired from the another portable device, then the device-priority setting unit sets the another portable device as the prioritized device.

Such configuration allows for readily setting the another portable device, which has become a transfer source of the place information set as the destination, as the prioritized device. To put it in another way, when another user besides the owner of the portable device that is set as the prioritized device drives the vehicle, all it is required for the another user to do is to simply make a transfer reservation of the place information. This user is not required to set his/her portable device as the prioritized device.

Optionally, the on-board device further includes a device-priority selection unit prompting the user to select whether the another portable device is to be set as the prioritized device when a destination has been set based on the place information acquired from the another device. The device-priority setting unit sets the another portable device as the prioritized device when the selection of “set as the prioritized device” is selected in the device-priority selection unit.

Such configuration allows for having the user select whether the another device is to be set as the prioritized device. Hence, the prioritized device setting will not be modified against the user's intention.

It is noted that the “device-priority selection unit” may include a display that displays a prompt dialogue for the user for a selection, or a speaker that prompts the user for a selection through audio guidance.

Optionally in the on-board device, the portable device is capable of registering destination information with time and date information, and the on-board device above further includes a destination information extraction unit that extracts, from among the acquired pieces of destination information, one or more piece(s) of destination information subject to setting a destination based on the time and date information when the communication unit establishes communication with other portable devices each having a transfer reservation of destination information therein or with another portable device having a plurality of transfer reservations of destination information therein, so that the place information acquisition unit acquires a plurality of pieces of destination information. The destination setting unit sets the destination based on the one or more piece(s) of destination information extracted by the destination information extraction unit.

Such configuration allows, even when a plurality of pieces of destination information has been acquired, for extracting one or more piece(s) of destination information based on the time and date information registered in the portable device. Hence, the user is not required to select the destination information subject to setting the destination on the on-board device. Accordingly, setting of the destination is quickly performed even when a plurality of pieces of destination information is acquired.

It is noted that when a plurality of pieces of destination information is extracted by the destination information extraction unit, the destination setting unit may be configured so as to set a plurality of destinations as stopovers based on the plurality of pieces of destination information, or to set a single destination and then automatically set the next destination after the route guidance to the single destination is ended. For the latter case, route guidance will be continuously performed for as many as the number of the pieces of destination information extracted.

Moreover, the on-board device above may further include a destination information selection unit that further filters (to have the user select) the destination information subject to setting the destination from among the one or more pieces of destination information extracted by the destination information extraction unit. It is noted that the “destination information selection unit” may include a display that displays a prompt dialogue for the user for a selection, or a speaker that prompts the user for a selection through audio guidance.

It is further noted that “time and date information” indicates information including a date, time, or days of the week. Furthermore, “time and date information” may be registered based on input information from the user, or registered (added) automatically with the time and date at/on which the place information is registered.

Optionally, the on-board device further includes a time and date condition setting unit that sets a condition of time and date for extracting destination information subject to setting the destination. The destination information extraction unit checks the time and date condition set by the time and date condition setting unit with the time and date information to extract one or more piece(s) of destination information from among the plurality of pieces of destination information.

Such configuration allows for the user to set a time and date condition on the on-board device for extracting destination information to his/her needs and likings.

It is noted that a “time and date condition” indicates a set of conditions relating to a date, time, days of the week or the like.

Optionally, the on-board device further includes a destination information selection unit that prompts the user to select, from among the acquired pieces of destination information, one or more piece(s) of destination information subject to setting the destination when the communication unit establishes communication with other portable devices each having a transfer reservation of destination information therein or with another portable device having a plurality of transfer reservations of destination information therein, so that the place information acquisition unit acquires a plurality of pieces of destination information, the destination information selection unit. The destination setting unit sets the destination based on the one or more piece(s) of destination information selected by the destination information selection unit.

Such configuration allows, even when a plurality of pieces of destination information has been acquired, for the user to select one or more piece(s) of destination information to set a desired destination.

It is noted that when a plurality of pieces of destination information is selected by the destination information selection unit, the destination setting unit may be configured so as to set a plurality of destinations as stopovers based on the plurality of pieces of destination information, or to set a single destination and then automatically set the next destination after the route guidance to the single destination is ended. For the latter case, route guidance will be continuously performed for as many as the number of the pieces of destination information selected.

It is noted that the “destination information selection unit” may include a display that displays a prompt dialogue for the user for a selection, or a speaker that prompts the user for a selection through audio guidance.

Optionally in the on-board device, the place information process unit includes a stopover setting unit that sets stopovers based on the plurality of pieces of destination information acquired when the communication unit establishes communication with other portable devices each having a transfer reservation of destination information therein or with another portable device having a plurality of transfer reservations of destination information therein, so that the place information acquisition unit acquires the plurality of pieces of destination information. The on-board device further includes a route guidance unit that guides through a route via the stopovers set by the stopover setting unit.

Such configuration allows, when a plurality of pieces of destination information is acquired, for setting a plurality of stopovers to perform route guidance via the plurality of stopovers.

It is noted that the route guidance unit may orderly guide through the route starting from the closer stopovers from the present location, or may guide through a route according to time and date information (such as expected arrival time) if such time and date information is added to each piece of destination information.

Optionally, the on-board device further includes a calculation unit that calculates either a required time it takes from the present location to a destination set as a destination by the place information process unit or an arrival time at the destination, and a notification unit that notifies the portable device being the transfer source of the place information of the required time or the arrival time calculated by the calculation unit.

Such configuration allows for the required time to the destination or the arrival time at the destination to be notified to the portable device that has transferred the place information, and hence, the notified information may be utilized for schedule management on the portable device.

It is noted that a transfer unit may be provided in a portable device of the transfer source of the place information so as to transfer the required time or arrival time notified from the on-board device to another information device. Such configuration allows for a convenience use of the notifications. For example, when a person A (another information device) sends an email to a person B (the portable device of the transfer source of the place information) to request a pick-up at a place X (place information), the required time to the place X or the arrival time at the place X may be notified to the person A.

Optionally, the on-board device further includes a delete instruction transmission unit that sends an instruction for deleting registration of the destination information or the place registration information to the portable device that is the transfer source of either the destination information set by the destination setting unit or the place registration information registered by the place registration unit.

Such configuration allows for a delete instruction to be sent to the portable device that is the transfer source of the place information used in the past, such as destination information set by the destination setting unit, or place registration information registered by the place registration unit, thus saving the effort in operating to delete the registered place information on the portable device.

An information communication system of the invention includes the on-board device and the portable device.

A computer program of the invention causes a computer to execute each step in the method for controlling communication of an on-board device.

With such configuration, an information communication system or a computer program that enables the on-board device to obtain from the portable device the place information designated by the user.

### BRIEF DESCRIPTION OF THE DRAWINGS

FIG. 1 is a control block diagram of an on-board device according to a first embodiment of the invention.

FIG. 2 is a functional diagram of an information communication system.

FIG. 3 is a flowchart showing operations of a portable device according to the first embodiment.

FIG. 4 is a flowchart showing operations of the on-board device according to the first embodiment.

FIG. 5 is a flowchart continued from FIG. 4.

FIG. 6 is a diagram showing an example of a selection screen of the destination information.

FIG. 7 is a flowchart showing operations of an on-board device according to a second embodiment of the invention.

FIG. 8 is a flowchart continued from FIG. 7.

FIG. 9 is a flowchart showing operations of a portable device according to a third embodiment of the invention.

FIG. 10 is a flowchart showing a serial process of an information communication system according to a fourth embodiment of the invention.

FIG. 11 is a flowchart showing operations of the portable device in relation to an instruction for deleting registration.

### BEST MODES FOR CARRYING OUT THE INVENTION

An on-board device, an information communication system, a method for controlling communication of the on-board device, and a computer program therefor will be described below. The present embodiment describes, as an example of the on-board device, an information device that is provided with a communication function to communicate with a portable device (for example, a portable telephone) and a car navigation function.

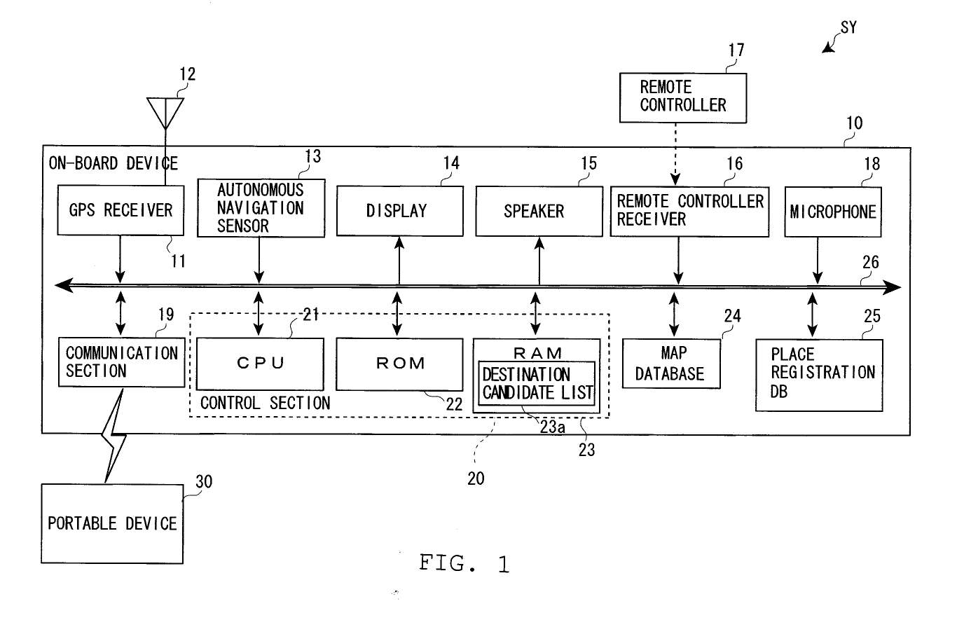

FIG. 1 is a control block diagram of an on-board device 10. As shown in the figure, the on-board device 10 includes a GPS (Global Positioning System) receiver 11, an antenna 12, an autonomous navigation sensor 13, a display 14, a speaker 15, a remote controller optical receiver 16, a remote controller 17, a microphone 18, a communication section 19, a control section 20, a map database (hereinafter referred to as “map DB”) 24, a place registration database (hereinafter referred to as “place registration DB”) 25, and a connection BUS 26. It is noted that the display 14 may or may not be disposed as a unit with the on-board device 10, and may be disposed independently.

The GPS (Global Positioning System) receiver 11 receives GPS information (including position information and time information) via the antenna 12. The autonomous navigation sensor 13 is constituted of an angular sensor and a distance sensor (both not shown) and used to specify a vehicle location in combination with the GPS receiver 11. The display 14 displays route guidance information, as well as various confirmation dialogues (a prompt dialogue for a user for confirmation) as needed. The speaker 15 outputs audio route guidance information and various audio confirmations (audio guidance to prompt the user for confirmation).

The remote controller optical receiver 16 obtains an operational signal from the remote controller 17. The remote controller 17 is used to perform various operations using an operation element, and is used mainly for inputting the user's response to the confirmation dialogues or to the audio guidance above in this embodiment. The microphone 18 is used for performing various operations while giving the user's hands free, and similarly to the remote controller 17, is used for inputting the user's response. The microphone 18 is also used to conduct a hands-free conversation, if a portable device 30 is a portable telephone.

The communication section 19 communicates with the portable device 30 via a Bluetooth communication (representing an example of wireless communication in this embodiment. “Bluetooth” is a registered trademark.), or an infrared communication. It is noted that the communication section 19 may conduct wired communication using a connection such as BUS without employing such contactless communication. The control section 20 is constituted of a CPU (Central Processing Unit) 21, a ROM (Read Only Memory) 22 and a RAM (Random Access Memory). The CPU 21 is a central processor and performs various computations. It is noted, although not specifically shown, the CPU 21 is provided with a timer that keeps time of the present time. The ROM 22 stores a control program for performing various computations by the CPU 21, and the RAM 23 is used as a work area for performing various computations by the CPU 21. It is noted that, in the RAM 23, a destination candidate list 23a for temporarily storing destination information subject to setting a destination is stored.

The map DB 24 stores map data used for route guidance. The place registration DB 25 stores place registration information registered as registered places, and generally the places the user visits frequently, such as home, a workplace, or a school, are registered as place registration information. Moreover, destination information that has been set as destinations are also registered as registered places to enable to be searched later. It is noted that place registration information and destination information are collectively named “place information” in the description below.

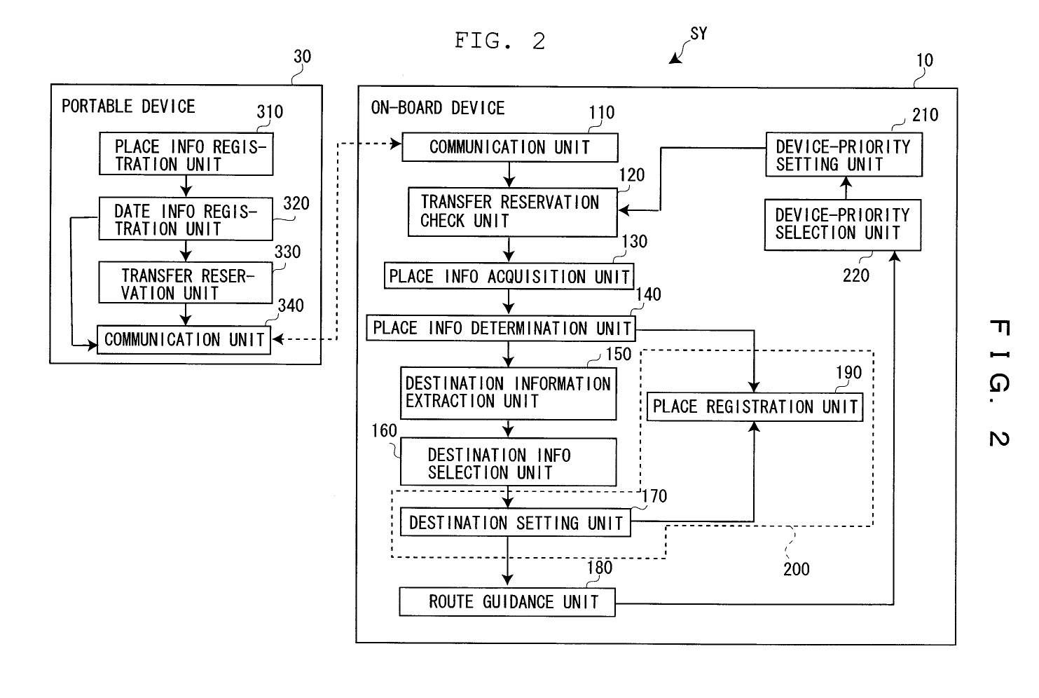

Next, a functional configuration of an information communication system SY constituted of the on-board device 10 and the portable device 30 will be described with reference to FIG. 2. As a functional configuration, the portable device 30 mainly includes a place information registration unit 310, a date information registration unit 320, a transfer reservation unit 330 and a communication unit 340.

The place information registration unit 310 enables the user to register, as place information, destination information for setting a destination or place registration information for registering a place. It is noted that, if the portable device 30 is a portable telephone, the place information may be selected from a phone book (address book) provided as a function of the portable telephone, or a marking on the map data resulted from an access to a map website. In the latter case, latitude and longitude or a map code will be the place information.

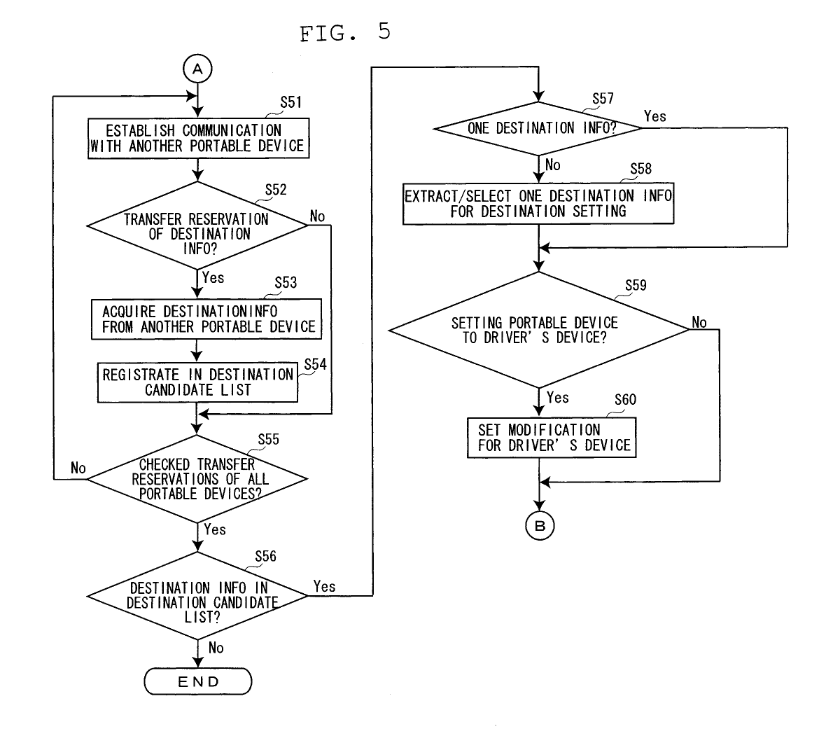

The date information registration unit 320 enables to register time and date information in association to place information to designate the time and date of use of the place information, and if the place information is destination information, time and date information can be registered (input) in this embodiment. It is noted that “time and date information” indicates information including a date, time, or days of the week. Accordingly, if the time and date information is a date, under the condition that the date and the communication time and date match, destination information subject to setting the destination may be extracted on the on-board device 10 (S58 of FIG. 5).

The transfer reservation unit 330 is used for making a transfer reservation of place information (time and date information included in the case of destination information). In the portable device 30 of the present embodiment, when the portable device 30 is unable to communicate with the on-board device 10, a transfer reservation will be automatically placed at a point when the user registers place information and a transfer thereof is instructed. It is noted that when the portable device 30 is communicable with the on-board device 10, the place information will be sent without any change. The communication unit 340 is used for inputting/outputting (sending/receiving) information with the on-board device 10, and mainly used to send place information. It is noted that information indicative of a category (destination information or place registration information) is sent simultaneously with the place information, or separately soon before or after the place information is sent.

Then, a functional configuration of the on-board device 10 will be described. As a functional configuration, the on-board device 10 mainly includes a communication unit 110, a transfer reservation check unit 120, a place information acquisition unit 130, a place information determination unit 140, a destination information extraction unit 150, a destination information selection unit 160, a destination setting unit 170, a route guidance unit 180, a place registration unit 190, a device-priority setting unit 210, and a device-priority selection unit 220. It is noted that the destination setting unit 170 and the place registration unit 190 realize a place information process unit 200.

The communication unit 110 is used for inputting/outputting information with the portable device 30, and the communication section 19 is a main configuration element thereof. The transfer reservation check unit 120 checks with the portable device 30 upon establishment of the communication therewith whether there is any transfer reservation of place information. If the transfer reservation check unit 120 has confirmed that there is a transfer reservation in the portable device 30, the place information acquisition unit 130 acquires place information from the portable device 30. It is noted that the control section 20 and the communication section 19 are main configuration elements of the transfer reservation check unit 120 and place information acquisition unit 130.

The place information determination unit 140 determines a category of processing relating to the place information acquired by the place information acquisition unit 130. More specifically, the place information determination unit 140 determines that the place information acquired is either destination information or place registration information. When the place information acquisition unit 130 has acquired a plurality of pieces of destination information, the destination information extraction unit 150 extracts one or more piece(s) of destination information subject to setting the destination from among the plurality of pieces of destination information based on time and date information acquired therewith. In this case, the time and date information added to the destination information and the communication time and date at/on which the communication is established by the communication unit 110 are checked, and when the communication time and date matches with the time and date information, the destination information extraction unit 150 extracts the destination information with the time and date information added thereto. It is noted that the control section 20 is a main configuration element of the place information determination unit 140 and the destination information extraction unit 150.

The destination information selection unit 160 is used for having the user to select one piece of destination information from among the plurality of pieces of destination information extracted by the destination information extraction unit 150. The control section 20, the display 14, the speaker 15, the remote controller 17 and the microphone 18 are main configuration elements of the destination information selection unit 160. In other words, the destination information selection unit 160 may display on the display 14 a prompt dialogue for the user for a selection of the one piece of destination information (final destination information selection dialogue), which is to be the last candidate for setting the destination, or may output audio guidance from the speaker 15 for the user for a selection of the one piece of destination information. The user may perform a selection using the remote controller 17 or the microphone 18.

The destination setting unit 170 sets a destination based on the one piece of destination information selected by the destination information selection unit 160. The control section 20 and the map DB 24 are main configuration elements of the destination setting unit 170. The route guidance unit 180 searches for the route to the destination set by the destination setting unit 170 and guides through the route (by displaying the route or audio guidance). The GPS receiver 11, the autonomous navigation sensor 13, the control section 20 and the map DB 24 are main configuration elements of the route guidance unit 180. The place registration unit 190 registers place information, which is either the place information set as the destination (destination information) by the destination setting unit 170 or the place information determined as the place registration information by the place information determination unit 140, to the place registration DB 25. The control section 20 and the place registration DB 25 are main configuration elements of the place registration unit 190.

The device-priority setting unit 210 sets a prioritized device, which is the portable device 30, a single portable device subject to prioritized communication with the communication unit 110. The display 14 and the remote controller 17 are main configuration elements of the device-priority setting unit. In other words, a device name or identification information (for example, a unique physical address of a hardware, namely MAC address or Bluetooth (registered trademark) address) of the portable device 30 subject to be the prioritized device may be set using the remote controller 17 on the display 14 displaying a prioritized-device setting dialogue. It is noted that the prioritized device is specifically the portable device 30 subject to be used in a hands-free telephone call, and/or the portable device 30 subject to be a connected device when connected to the Internet. In the description below, the portable device 30 set as the prioritized device is referred to as a “driver's device”.

When the transfer reservation check unit 120 has checked whether there is a transfer reservation in another portable device 30 besides the driver's device, the place information acquisition unit 130 has acquired destination information from the another portable device 30, and the destination setting unit 170 has set the destination based on the destination information, then the device-priority selection unit 220 prompts the user to select whether the another portable device 30 is to be set as the driver's device. When the user selects to “set as the driver's device”, then the device-priority setting unit 210 sets the another portable device 30 to be the driver's device. It is noted that the control section 20, the display 14, the speaker 15, the remote controller 17 and the microphone 18 are the main configuration elements of the device-priority selection unit, similarly to the destination information selection unit 160.

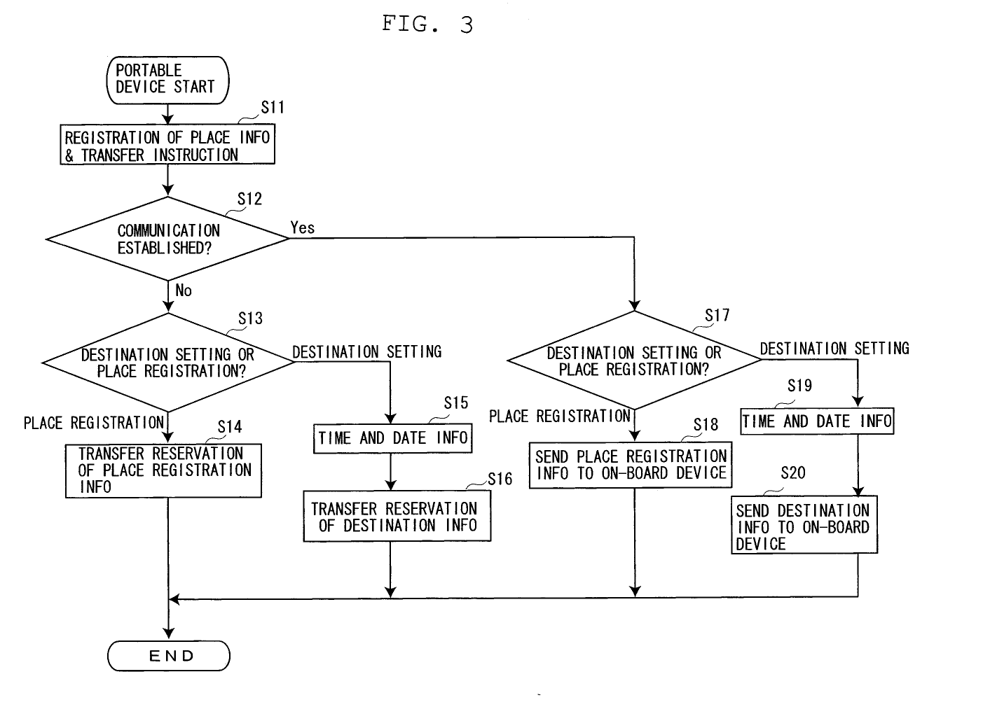

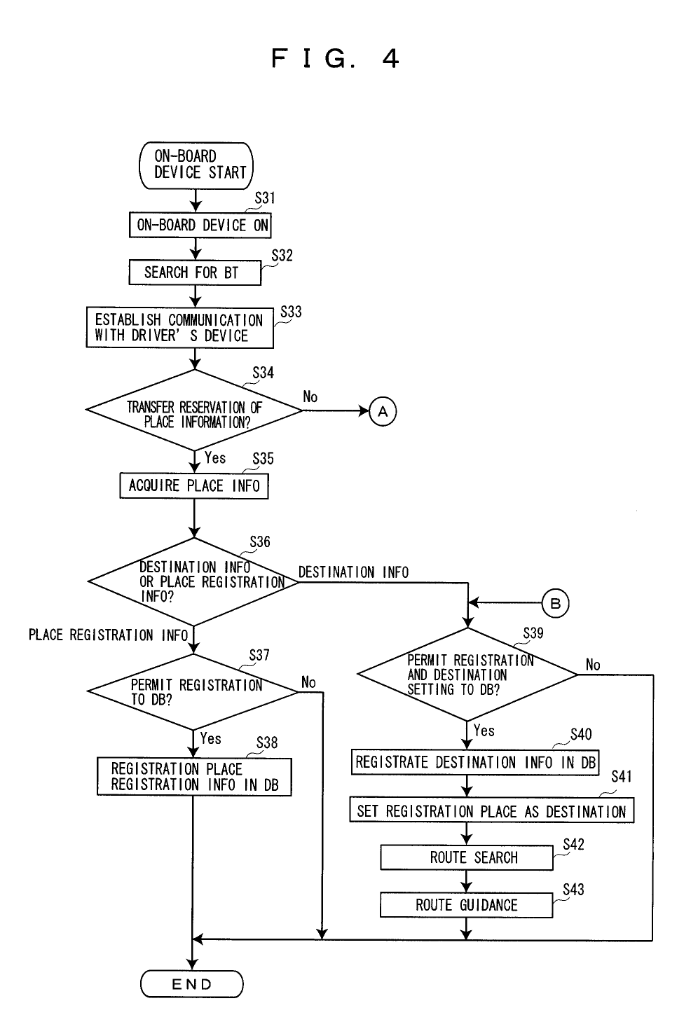

Next, operations of the portable device 30 and the on-board device 10 according to the first embodiment will be described with reference to the FIGS. 3 to 5. FIG. 3 is a flowchart showing operations (of a transfer process of place information) of the portable device 30. FIG. 4 and FIG. 5 are flowcharts showing operations (of a serial process from communicating with the portable device 30 to starting route guidance) of the on-board device 10.

As shown in FIG. 3, after the user instructs to register place information and to transfer the place information (S11), the portable device 30 determines whether the communication with the on-board device 10 is established (S12). If no communication is established (S12: No), the portable device 30 determines whether the place information registered is for the purpose of setting the destination or registering the place (S13). The determination is made based on which section, a set-destination section or register-place section, the place information has been entered, or the category designation made soon before or after the place information is input.

In S13, when it is determined that the purpose has been for registering the place, then the portable device 30 reserves a transfer of the place registration information (S14). Furthermore, in S13, when it is determined that the purpose has been for setting the destination, then the portable device 30 prompts the user to enter time and date information (S15) and, when the time and date information is input, makes a transfer reservation of the destination information (to which the time and date information is added) (S16).

On the other hand, when the communication with the on-board device is established (S12: Yes), similarly to S13, the portable device 30 determines whether the purpose has been for setting the destination or registering the place (S17). When it is determined that the purpose has been for registering the place, then the portable device 30 sends the place registration information to the on-board device 10 (S18). Furthermore, when it is determined that the purpose has been for setting the destination, the portable device 30 prompts the user to enter time and date information (S19), and, when the time and date information is input, sends the destination information (to which the time and date information is added) to the on-board device 10 (S20).

It is noted that, in the above flowchart, inputting the destination information (S15, S19) and registration of place information (S11) may be performed at once. It is further noted that it may be configured to be able to make a transfer reservation when the communication is established (S12: Yes).

Next, operations of the on-board device 10 will be described. Assumed herein is that the driver's device is already set, and the driver's device is turned on (communicable). As shown in FIG. 4, when the on-board device 10 is turned on (S31), the communication section 19 searches for Bluetooth (registered trademark) of the portable device 30 (S32). When the communication with the driver's device, which is set as the prioritized device, is established (S33), the on-board device 10 determines whether there is any transfer reservation of place information in the driver's device (S34).

When the driver's device has a transfer reservation (S34: Yes), the on-board device 10 acquires the place information from the driver's device (S35), and determines whether the place information is for the purpose of setting the destination or for registering the place (S36). When the on-board device 10 has determined that the purpose has been for registering the place, then it further determines whether the user permits registration to the place registration the place registration DB 25 (S37). That is, the on-board device 10 displays on the display 14 a dialogue to prompt the user for a selection of whether a registration to the place registration DB 25 is permitted, and acquires the selection operation made on the dialogue. When the user permits the registration to the place registration DB 25 (S37: Yes), then the on-board device 10 registers the place registration information to the place registration DB 25 (S38). When the user does not permit the registration to the place registration DB 25 (S37: No), then the on-board device 10 ends the process.

On the other hand, in S36, when the place information acquired is determined as destination information, then the on-board device 10 determines whether the user permits registration to the place registration DB 25, and setting the destination (S39). When the user permits the above (S39), the on-board device 10 registers the destination information as a registered place to the place registration DB 25, and sets the registered place as the destination (S41). Then, the on-board device 10 searches for the route to the destination (S42) and guides through the route (S43). In S39, when the user does not permit that (S39: No), the on-board device 10 ends the process.

Next, operations when the driver's device has no transfer reservation (in FIG. 4, S34: No) will be described with reference to FIG. 5. Assumed herein is that there are at least one or more communicable portable devices 30 besides the driver's device present in the vehicle. When the communication with another portable device 30 besides the driver's device (S51) is established, the on-board device 10 determines whether there is a transfer reservation of destination information in the another portable device 30 (S52). When there is a transfer reservation of destination information (S52: Yes), the on-board device 10 acquires the destination information from the another portable device 30 (S53), and registers to the destination candidate list 23a (see FIG. 1) (S54). In other words, even when there is a transfer reservation of place registration information in the another portable device 30, the on-board device 10 ignores (does not acquire) that reservation (S52: No).

Then, the on-board device 10 determines whether a check for transfer reservations in all of the portable devices 30 (other portable devices 30) has been performed (S55), and if not determined (S55: No), the processes of S51 to S55 are repeated. If it is determined that the check for transfer reservations in all of the portable devices 30 is performed (S55: Yes), the on-board device 10 determines whether the destination information is on the destination candidate list 23a (S56), and if there is no destination information therein (S56: No), then it ends the process.

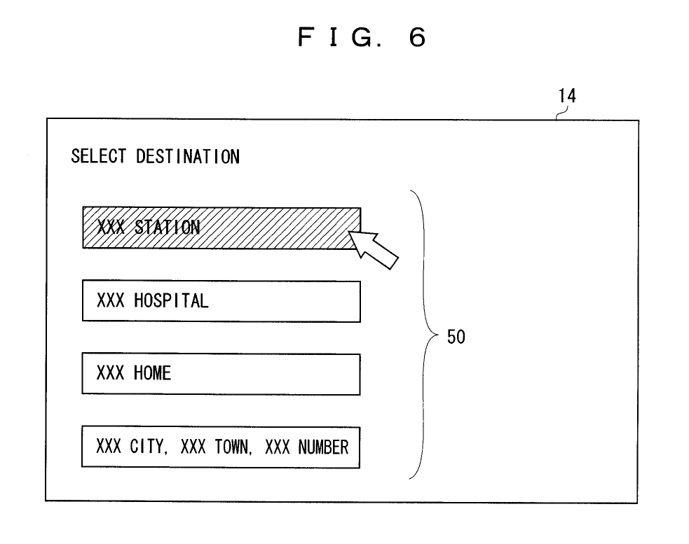

On the other hand, when there is destination information therein (S56: Yes), the on-board device 10 determines whether there is a single piece of destination information (S57), and if not (S57: No), it extracts and selects one piece of destination information (based on the time and date information) subject to setting the destination (S58). The Step S58 is realized by the destination information extraction unit 150 and the destination information selection unit 160. FIG. 6 is an example drawing of a selection dialogue for selecting place information displayed on the display 14. In the drawing, the extracted pieces of place information are displayed as selection candidates 50. As for the destination information, place names like “XXX train station” or “XXX hospital” may be displayed, or home names or addresses like “XXX's home” or “XXX City, XXX Town, XXX District, XXX Number” may be displayed. The difference in the appearances is due to the difference in how the place information has been registered in the portable device 30. For example, when the destination information is registered as a result of accessing the map website and marking directly on the map data from the portable device 30, the place name will be displayed as in the former case. When the destination information is registered as a result of selecting a telephone number or an address from the address book in the portable device 30, then the home name or the address will be displayed as in the latter case. It is noted that, although not shown in the flowchart, other pieces of destination information than the selected piece of destination information in S58 (by the destination information selection unit 160) are deleted from the destination candidate list 23a.

Moreover, when either a single piece of destination information is selected (S58) or there is only a single piece of destination information (S57: Yes), the on-board device 10 prompts the user for a selection of whether the user wishes to set the portable device 30 that is the transfer source of the destination information as the driver's device (S59), and if the selection is to “set as the driver's device” (S59: Yes), the on-board device 10 modifies the setting for the driver's device (S60) and performs S39 of FIG. 4 and the rest of the operations. If the selection is to “not set as the driver's device” (S59: No), the on-board device 10 performs S39 of FIG. 4 and the rest without modifying the setting for the driver's device.

It is noted that in the above flowcharts, the check processes, S37, S39 in FIGS. 4 and S59 in FIG. 5, may be omitted. It is further noted that transfer reservations of place registration information in another portable device 30 besides the driver's device may be checked, and if there is a transfer reservation, then the on-board device 10 may acquire the transfer reservation. On the other hand, on the other hand, a transfer reservation for only destination information may be checked in the driver's device. In other words, if the acquired place information is place registration information (S36: place registration information), the on-board device 10 may end the process.

Moreover, in S58 of FIG. 5, when the communication time and date and the time and date information do not match as a result of extracting the destination information and thus no destination information is extracted, then the on-board device 10 may select a single piece of destination information from all of the destination information on the destination candidate list 23a. However, in such a case, it is preferable to display a message such as that the communication time and date and the time and date information did not match on the display 14, and then prompt the user for a selection. Furthermore, in S58 of FIG. 5, if only one piece of destination information is extracted as a result of extracting the destination information, then the on-board device 10 may skip the selection confirmation of place information to the user.

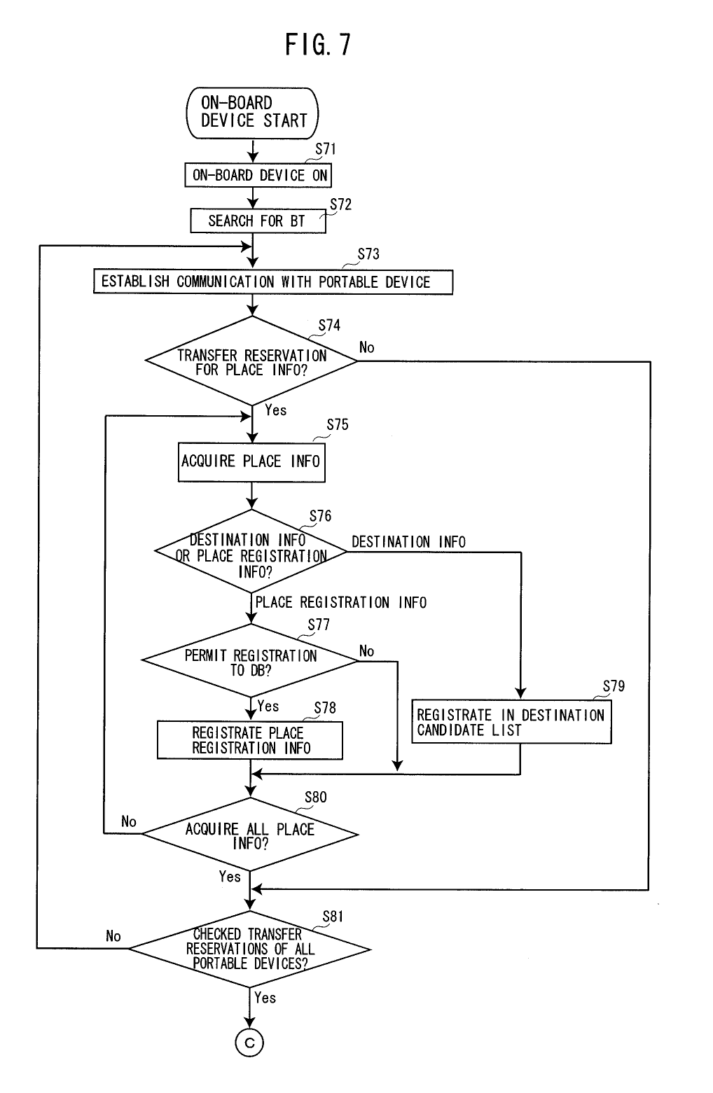

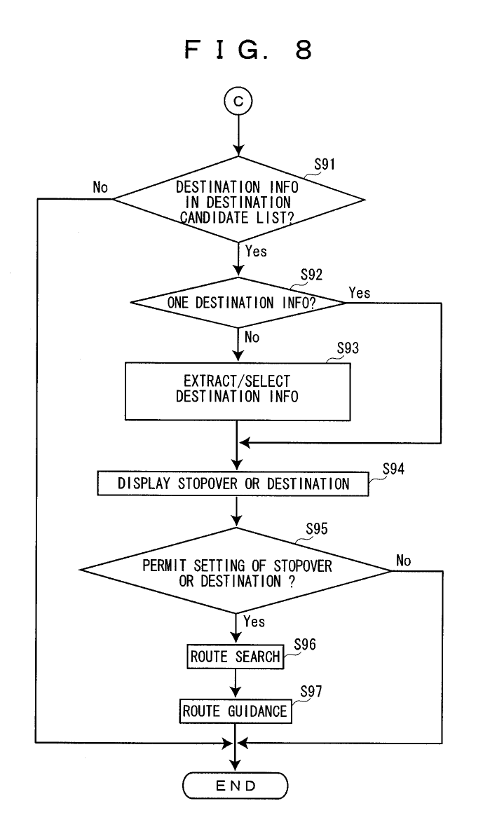

Next, a second embodiment of the invention will be described with reference to FIG. 7 and FIG. 8. In the first embodiment above, the on-board device 10 first checks with the driver's device whether there is a transfer reservation, and if there is none in the driver's device, then checks with other portable devices 30 whether there is a transfer reservation. This embodiment differs in that the on-board device 10 checks whether there is a transfer reservation with all communicable portable devices 30 regardless of being the driver's device or not. Furthermore, this embodiment differs from the first embodiment in that the on-board device 10 acquires all pieces of the place registration information that are reserved for transfer in all of the communicable portable devices 30 to register the places, and more than one destinations (stopovers) may be set. Operations of the on-board device 10 according to the second embodiment will be described with reference to the flowchart. Assumed herein as well is that there is at least one or more communicable portable devices 30 present in the vehicle. Operations of the portable devices 30 is the same as the first embodiment, therefore the description thereof is omitted.

As shown in FIG. 7, when turned on (S71), the on-board device 10 searches for Bluetooth (registered trademark) (S72) and establishes communication with a portable device 30 (S73). Then the on-board device 10 determines whether there is a transfer reservation in the portable device, with which the communication is established (S74). If there is a transfer reservation (S74: Yes), the on-board device 10 acquires place information from the portable device 30 (S75), and determines whether the place information is destination information or place registration information (S76). If the place information is determined as place registration information, the on-board device 10 determines whether the user permits registration to the place registration DB 25 (S77). If permitted (S77: Yes), the on-board device 10 registers the place registration information to the place registration DB 25 (S78). If the place information is determined as destination information in S76, the on-board device 10 registers that to the destination candidate list 23a (S79).

Then, the on-board device 10 determines whether all pieces of the place information reserved for transfer are acquired (S80), and if not acquired (S80: No), the processes of S75 to S80 are repeated. If all pieces of the place information are acquired (S80: Yes), the on-board device 10 determines whether a check for transfer reservations in all of the communicable portable devices 30 has been performed (S81), and if not checked (S81: No), the processes of S73 to S81 are repeated. If transfer reservations in all of the portable devices 30 are checked (S81: Yes), the on-board device 10 moves on to the operations shown in FIG. 8.

As shown in FIG. 8, the on-board device 10 which has completed the check for transfer reservations in all of the portable devices 30 determines whether any destination information is on the destination candidate list 23a (S91), and if there is none of destination information (S91: No), the on-board device 10 ends the process. If there is destination information (S91: Yes), the on-board device 10 determines whether there is a single piece of destination information (S92), and if it is not a single piece, the on-board device 10 extracts and selects one or more piece(s) of destination information for use (based on the time and date information) (S93). The step S93 as well is realized by the destination information extraction unit 150 and the destination information selection unit 160. Other pieces of destination information than the finally-selected piece of destination information in S93 are deleted from the destination candidate list 23a.

Then, the on-board device 10 displays the stopovers or destinations according to a result of extraction and selection in S93. In other words, if a single piece of destination information is extracted (or selected), the destination is set. If a plural pieces of destination information are extracted (or selected), the stopovers are set (the stopover setting unit). In the latter case, the on-board device 10 may orderly display the closer stopover from the present location among the plurality of stopovers, or may display the stopovers according to the time and date information (such as expected arrival time) added to each piece of destination information. When it is determined that the destination candidate list 23a has only a single piece of destination information (S92: Yes), the destination based on the single piece of destination information is displayed (S94).

Then, the on-board device 10 determines whether the user permits registration of the stopovers or setting of the destination (S95), and if permitted by the user (S95: Yes), the on-board device 10 searches for the route (S96) and guides through the route (S97). If the user does not permit that (S95: Yes), the on-board device 10 ends the process.

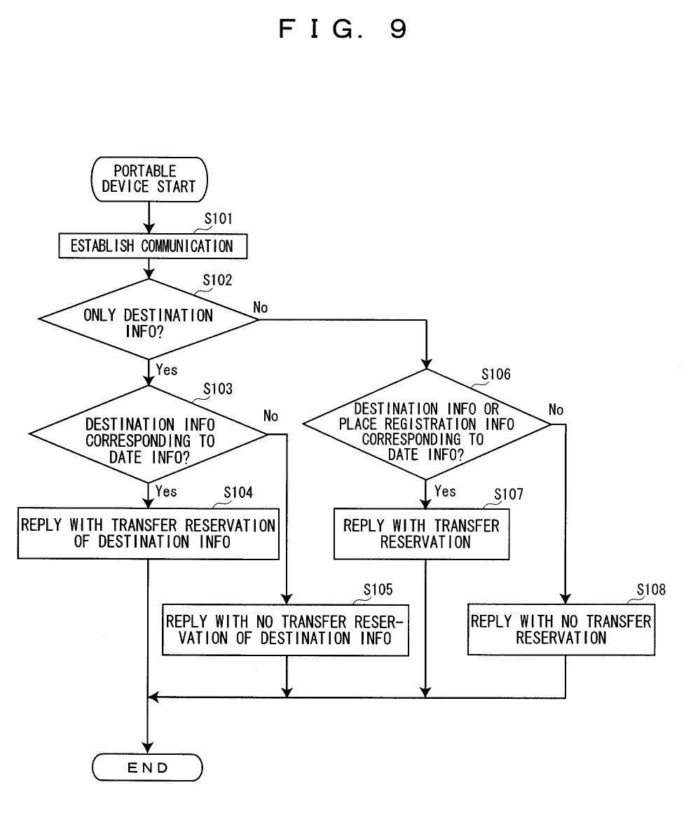

Next, a third embodiment of the invention will be described with reference to FIG. 9. In the first embodiment and the second embodiment above, the destination information subject to setting the destination or stopovers is extracted by the on-board device 10. This embodiment differs in that the portable device 30 extracts (determines) that. Operations of the portable device 30 according to the third embodiment will be described with reference to the flowchart. Assumed herein is that, the registration of the place information and the registration of the time and date information, place information is destination information in this case, have already been performed.

When the communication with the on-board device 10 is established (S101), the portable device 30 determines whether a transfer reservation check from the on-board device 10 is only for checking destination information (S102). If the transfer reservation check is only for destination information (S102: Yes), the portable device 30 determines whether there is a piece of destination information whose communication time and date match with the time and date information. When there is a piece of destination information with the matching time and date information (S103: Yes), the portable device 30 responds to the on-board device 10 that there is a transfer reservation for destination information (S104). If there is no destination information with the matching time and date information (S103: No), the portable device 30 responds to the on-board device 10 that there is no transfer reservation for destination information (S105).

On the other hand, if a transfer reservation check is not only for destination information (S102: No), the portable device 30 determines whether there is either a piece of destination information whose communication time and date match with time and date information or a piece of place registration information (S106). When there is either of the information (S106: Yes), the portable device 30 responds to the on-board device 10 that there is a transfer reservation (S107). If there is neither of the information (S106: No), the portable device 30 responds to the on-board device 10 that there is no transfer reservation (S108).

It is noted that, in the above flowchart, it is determined whether a transfer reservation check is only for destination information (see S102), but the portable device 30 may determine a category of the place information and respond whether there is a transfer reservation for each of the categories. It is further noted that, for a transfer reservation check from the on-board device 10 in which no category is specified, the portable device 30 may respond whether there is a transfer reservation for both categories in such a way that “there is a transfer reservation for place registration information, and there is no transfer reservation for destination information”.

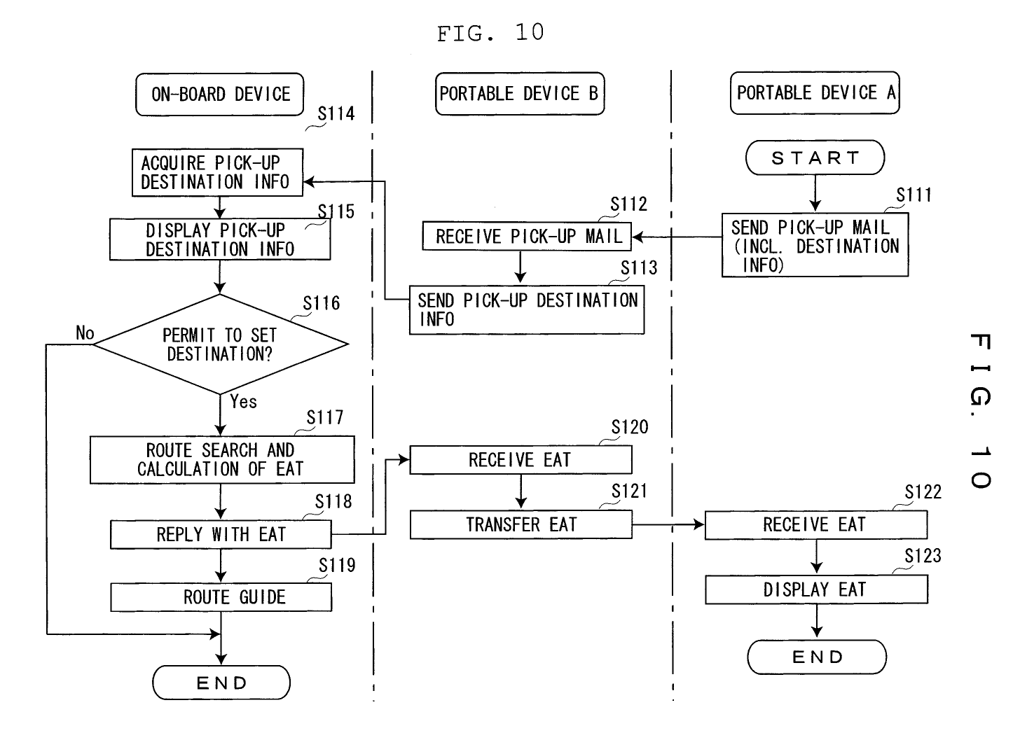

Next, a fourth embodiment of the invention will be described with reference to FIG. 10. This embodiment is an application example using each of the above embodiments, and is an information communication system SY in which convenience is pursued in a case where a driver (a driver of a vehicle on which the on-board device 10 is equipped) is requested by a person to pick up the person at a particular place. Hereinafter, a portable device possessed by the person is referred to as a “portable device A”, a portable device possessed by the driver is referred to as a “portable device B”. A serial process that occurs in between the portable device A, the portable device B and the on-board device 10 will be described. It is noted that, in this embodiment, a description of a process of a transfer reservation check by the on-board device 10 is omitted, and the on-board device 10 and the portable device B are assumed to be communicable at all times.

First, the portable device A sends a “pick-up email”, which is an email for requesting a pick-up, to the portable device B (S111). It is noted that the destination information and the information about the email being a “pick-up email” are included in the pick-up email. It is further noted that, when the portable device A is equipped with a function enabling to locate the present location such as a GPS receiver, it is preferable to be able to automatically acquire the current location information at a startup of a pick-up email function, set the current location information as destination information and send the pick-up email.

When the portable device B receives the pick-up email from the portable device A (S112), the portable device B sends the destination information for the pick-up (hereinafter referred to as “pick-up destination information”) to the on-board device 10 (S113). It is noted that the pick-up destination information has the information about being the destination information for the pick-up added thereto.

The on-board device 10, having acquired the pick-up destination information from the portable device B (S114), displays the pick-up destination information on the display 14 (S115), and determines whether the user permits the destination to be set (S116). If permitted to set the destination (S116), the on-board device 10 searches for the route and calculates the expected arrival time (or the required time from the present location of the vehicle to the destination) (S117, a calculation unit), and replies to the portable device B with the calculated expected arrival time (S118, a notification unit). It is noted that the step S118 is an additional process in the case when the pick-up destination information is acquired. Then, the on-board device 10 guides through the route based on the result of the route search (S119). It is noted that, if the user does not permit the destination to be set, then the on-board device 10 ends the process.

The portable device B, having received the expected arrival time from the on-board device 10 (S120), transfers the expected arrival time to the portable device A (S121). It is noted that information regarding the transferring destination is stored when the pick-up email is received in S112. The portable device A, having received the expected arrival time from the portable device B, displays the expected arrival time on a display provided on the portable device A.

As such, according to the information communication system SY of the fourth embodiment of the invention, it is convenient that the person who requests for a pick-up can confirm the expected arrival time by sending the pick-up email. Moreover, a person who goes to pick up only has to perform a permitting operation of the destination to be set after receiving the pick-up email, and does not have to note about a receipt of the email or the expected arrival time. Therefore, even while driving, there is no issue in handling that.

If the system of the fourth embodiment is applied to a use of taxis, customers are able to reserve a taxi using the portable device 30, enabling a simple and convenient use of the taxis. For a taxi company as well, it enables a quick and accurate dispatch of taxis. Furthermore, if the taxi company owns a plurality of vehicles, the system may be configured by preparing a management server that integrally manages the plurality of vehicles so that pick-up emails are sent to the management server. In this case, the management server preferably specifies the closest vehicle from the destination based on the destination information contained in the pick-up email, and transfers the pick-up email to the on-board device 10 on the vehicle.

As described above, the on-board device 10 of the invention determines whether the place information received from the portable device 30 is for the purpose of registering the place or setting the destination, and thus the two categories of the place information (place registration information and destination information) may be distinguishably saved on the portable device 30. Accordingly, place registration or destination setting may be performed in advance on the portable device 30, thus saving the effort in doing so on the on-board device 10 after the user gets on the vehicle. In the information communication system SY of the invention, a transfer reservation is made in the portable device 30, and the on-board device 10 acquires the place information after checking the transfer reservation, and thus no other unintended place information by the user will be transferred to the on-board device 10. Furthermore, the transfer reservation is checked upon establishment of the communication with the portable device 30, and hence no other special operation is required for the user to acquire place information, and there is no concern associated with missing the information that should have been acquired. In other words, the acquisition of the desired place information by the user can be performed in a fast and reliable manner.

It is noted that, in the above embodiments, time and date information may be registered with the destination information, and one or more piece(s) of destination information subject to setting the destination is extracted based on the time and date information (in the fourth embodiment, a response of whether there is a transfer reservation of destination information is made based on the time and date information), but the time and date information may be registered with not only the destination information, but also with the place registration information.

It is further noted that, in the above embodiments, the time and date information input by the user may be registered with place information (destination information) (see S15 and S19 in FIG. 3), but the time and date at/on which the user registered the place information may be used as the time and date information. In other words, in this case, the user does not need to register the time and date information (only needs to register the place information) despite whether it is destination information or place registration information. In this case, extracting one or more piece(s) of place information subject to setting the destination is performed based on whether the communication time and date matches with the time and date information (registration date) or whether the time and date information (registered day of the week) matches with the day of the week of the communication time and date.

Furthermore, it has been described that the time and date information needs to be input as destination information is registered, but it may be configured so as not to require an input of the time and date information. In this case, the portable device 30 automatically adds the registration time and date (the time and date of the last access) if no registration of the time and date information is performed. On the other hand, the on-board device 10 may be configured to determine whether there is time and date information associated to the plurality of pieces of place information acquired before extracting the place information, and if there is any piece of place information with no time and date information added thereto, to extract only a piece of place information having the latest registration time and date. Furthermore, the on-board device 10 may be configured to extract only those pieces of place information registered within the last 24 hours from the plurality of pieces of place information acquired, without determining whether there is the time and date information. Still furthermore, the on-board device 10 may be configured to enable the user to customize how the time and date information is handled (whether to extract place information based on the time and date information, whether to extract a piece of place information with no time and date information registered, and etc.).

In the embodiments above, the destination information is extracted based on whether the time and date information and the communication time and date match, but the on-board device 10 may set a time and date condition for extracting the destination information (a time and date setting unit). In this case, the destination information extraction unit 150 extracts the destination information by checking the time and date condition set with the time and date information acquired. The time and date condition may be set as, the time and date information indicating from the date XX to the date YY is subject to be extracted, the time and date information indicating from XX day of the week to YY day of the week is subject to be extracted, the time and date information indicating a date within XX days from the communication time and date is subject to be extracted, and etc. Such configuration allows for the user to set a time and date condition on the on-board device 10 for extracting destination information to his/her needs and likings.

Moreover, the time and date information may be used, not for extracting the place information based on the time and date information, but for displaying the time and date information on a final destination information selection dialogue (a prompt dialogue for the user for a selection of one piece of destination information, which is to be the last candidate for setting the destination). In this case, on the final destination information selection dialogue, such cases may be considered in which the selection candidates of the place information are orderly displayed by the time and date information (registration time and date) from the latest, the pieces of place information having the time and date information that indicates a date within XX days from the communication time and date added thereto are displayed as the selection candidates, the selection candidates of the place information by days of the week indicated in the time and date information are displayed, and etc.

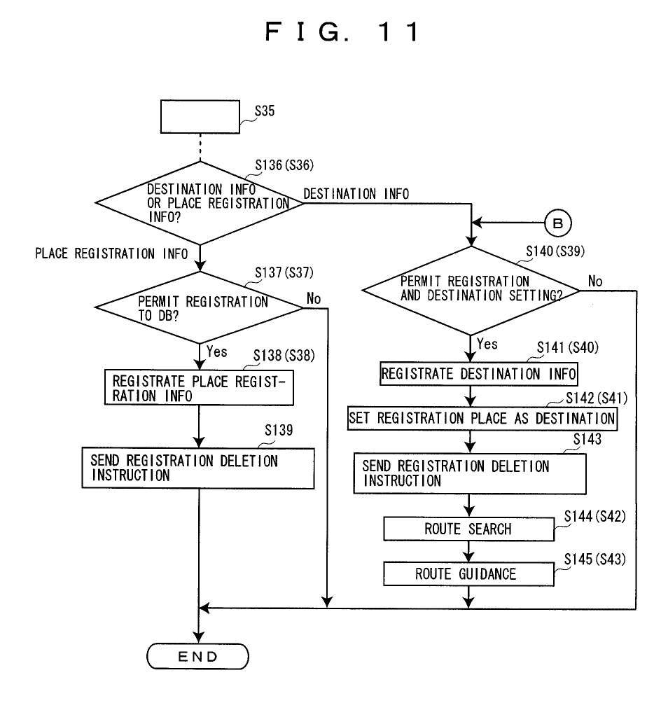

Furthermore, a delete instruction transmission unit (not shown) that sends to the portable device 30 an instruction for deleting registration of the place information may be added in the configuration of the on-board device 10 shown in FIG. 2. The delete instruction transmission unit sends an instruction for deleting registration of the destination information or the place registration information to the portable device 30, which is the transfer source of either the destination information set by the destination setting unit 170 or the place registration information registered by the place registration unit 190. Now, operations of the on-board device 10 relating to the instruction for deleting registration will be described with reference to the flowchart of FIG. 11. It is noted that the figure shows the operations executed after S35 of FIG. 4, and the numbers in parenthesis show the corresponding step numbers respectively. The on-board device 10 determines whether the place information acquired from the driver's device is destination information or place registration information (S136), and if it is determined to be the place registration information, the on-board device 10 further determines whether the user permits registration to the place registration DB 25 (S137). When the user permits the registration to the place registration DB 25 (S137: Yes), the on-board device 10 registers the place registration information to the place registration DB 25 (S138), and sends an instruction for deleting registration of the place registration information to the portable device 30, which is the transfer source of the place registration information (S139). The portable device 30, having received the instruction for deleting registration, deletes the applicable place registration information. If the user does not permit the registration to the place registration DB 25, the on-board device 10 ends the process. On the other hand, in S136, when the place information acquired is determined as the destination information, then the on-board device 10 determines whether the user permits registration to the place registration DB 25, and setting the destination (S140). If the user permits that (S140: Yes), the on-board device 10 registers the destination information as a registered place to the place registration DB 25 (S141), sets the registered place as the destination (S142), and sends an instruction for deleting registration of the destination information to the portable device 30, which is the transfer source of the destination information (S143). The portable device 30, having received the instruction for deleting registration, deletes the applicable destination information. Then, the on-board device 10 searches for the route to the destination that has been set (S144), and guides through the route (S145). In 5140, when the user does not permit that (S140: No), the on-board device 10 ends the process. Such configuration allows for saving the effort in operating to delete the registered place information on the portable device 30, because the place information utilized in the on-board device 10 will no longer be necessary in general.

Furthermore, in the above embodiment, the place information is acquired after the portable device 30 has been checked for whether there is a transfer reservation of place information (see S34 of FIG. 4, S52 of FIG. 5, and S74 of FIG. 7), the check for the transfer reservation may be omitted. In other words, the registered place information in the portable device 30 may be directly read out without checking for whether there is a transfer reservation. Still furthermore, a category of processing relating to the place information is determined after the acquisition of the place information (see S36 of FIG. 4 and S76 of FIG. 7), but the determination process may be skipped. In other words, the on-board device 10 may determine all the place information acquired from the portable telephone 30 as either place registration information of destination information and then move on the rest of the process.

It is noted that each of the configuration elements of the on-board device 10 or the portable device 30 of the above embodiments may be provided through a computer program. It is further noted that the computer program may be stored in and provided as a recording medium (not shown). In other words, a computer program that makes a computer function as each of the configuration elements of the on-board device 10 or the portable device 30 and a recording medium on which the computer program is stored are included in the scope of the claims of this invention. Any other modifications may be made without departing from the spirit of the invention.

### Reference Numerals

10 on-board device
11 GPS receiver
12 antenna
13 autonomous NAVIGATION sensor
14 display
15 speaker
16 remote controller optical receiver
17 remote controller
18 microphone
19 communication section
20 control section
21 CPU
22 ROM
23 RAM
23a destination candidate list
24 map database
25 place registration database
26 connection BUS
30 portable device
SY information communication system

1. An on-board device comprising:
a communication unit that carries out communication with a portable device that has a transfer reservation function of place information indicating an arbitrary place;
a place information acquisition unit that acquires the place information from the portable device after the communication is established;
a place information processing unit that at least registers a place or sets a destination using the place information; and
a deletion instruction transmission unit that sends a registration deletion instruction of the place information to the portable device that is the transfer source of the place information.

2. The on-board device according to claim 1, wherein
the place information is either destination information indicating the destination, or place registration information for registering a place,
the place information determination unit determines if the place information acquired by the place information acquisition unit is either the destination information or the place registration information,
the place information process unit including a place registration unit that registers the place based on the place registration information if the place information is determined to be the place registration information, and a destination setting unit that sets the destination based on the destination information if the place information is determined to be the destination information.

3. The on-board device according to claim 1, further comprising:
a transfer reservation check unit that checks with the portable device whether there is any transfer reservation of the place information upon establishment of the communication with the portable device, wherein
the place information acquisition unit acquires the place information from the portable device when the transfer reservation check unit has confirmed that there is a transfer reservation in the portable device.

4. The on-board device according to claim 1, further comprising:
a route guidance unit that guides through a route to the destination set by the place information process unit.

5. The on-board device according to claim 1, further comprising:
a device-priority setting unit that sets a prioritized device that is one portable device subject to prioritized communication by the communication unit, wherein
the place information acquisition unit first attempts to acquire place information from the prioritized device, and when no place information to be transferred is available in the prioritized device and communication with another portable device besides the prioritized device is established by the communication unit, the place information acquisition unit attempts to acquire place information from the another portable device.

6. The on-board device according to claim 3, further comprising:
a device-priority setting unit that sets a prioritized device that is one portable device subject to prioritized communication by the communication unit; wherein
the transfer reservation check unit first checks whether there is any transfer reservation in the prioritized device, and when no transfer reservation is confirmed in the prioritized device and communication with another portable device besides the prioritized device is established by the communication unit, the transfer reservation check unit checks whether there is any transfer reservation in the another device.

7. The on-board device according to claim 6, wherein
the device-priority setting unit sets the another portable device as the prioritized device when the place information process unit has set a destination using the place information acquired from the another portable device.

8. The on-board device according to claim 7, further comprising:
a device-priority selection unit prompting the user to select whether the another portable device is to be set as the prioritized device when a destination has been set based on the place information acquired from the another device, wherein
the device-priority setting unit sets the another portable device as the prioritized device when the selection of “set as the prioritized device” is selected in the device-priority selection unit.

9. The on-board device according to claim 2, wherein
the portable device is capable of registering destination information with time and date information, and
the on-board device further includes a destination information extraction unit that extracts, from among the acquired pieces of destination information, one or more piece(s) of destination information subject to setting a destination based on the time and date information when the communication unit establishes communication with other portable devices each having a transfer reservation of destination information therein or with another portable device having a plurality of transfer reservations of destination information therein, so that the place information acquisition unit acquires a plurality of pieces of destination information, and
the destination setting unit sets the destination based on the one or more piece(s) of destination information extracted by the destination information extraction unit.

10. The on-board device according to claim 9, further comprising:
a time and date condition setting unit that sets a condition of time and date for extracting destination information subject to setting the destination, wherein
the destination information extraction unit checks the time and date condition set by the time and date condition setting unit with the time and date information to extract one or more piece(s) of destination information from among the plurality of pieces of destination information.

11. The on-board device according to claim 2, further comprising:
a destination information selection unit that prompts the user to select, from among the acquired pieces of destination information, one or more piece(s) of place information subject to setting the destination when the communication unit establishes communication with other portable devices each having a transfer reservation of destination information therein or with another portable device having a plurality of transfer reservations of destination information therein, so that the place information acquisition unit acquires a plurality of pieces of destination information, and
the destination setting unit sets the destination based on the one or more piece(s) of destination information selected by the destination information selection unit.

12. The on-board device according to claim 2, wherein
the place information process unit includes a stopover setting unit that sets stopovers based on the plurality of pieces of destination information acquired when the communication unit establishes communication with other portable devices each having a transfer reservation of destination information therein or with another portable device having a plurality of transfer reservations of destination information therein, so that the place information acquisition unit acquires the plurality of pieces of destination information, and
the on-board device further includes a route guidance unit that guides through a route via the stopovers set by the stopover setting unit.

13. The on-board device according to claim 1, further comprising:
a calculation unit that calculates either a required time it takes from the present location to a destination set as a destination by the place information process unit or an arrival time at the destination; and
a notification unit that notifies the portable device being the transfer source of the place information of the required time or the arrival time calculated by the calculation unit.

14. (canceled)

15. An information communication system comprising:
the on-board device according to claim 1; and
the portable device.

16. A method for controlling communication of an on-board device communicable with a portable device having a transfer reservation function of place information indicating an arbitrary place, the method comprising, performed by the on-board device:
acquiring the place information from the portable device after communication is established;
at least registering a place or setting a destination using the place information, and
sending a registration deletion instruction of the place information to the portable device that is the transfer source of the place information.

17. A computer readable medium encoded with a computer program for causing a computer to execute each step in the method for controlling communication of an on-board device according to claim 16.
